(19) United States
(12) Patent Application Publication
(10) Pub. No.: US 2008/0283260 A1
(43) Pub. Date: Nov. 20, 2008

(54) Hand-held power tool having lubricated percussion mechanism

(76) Inventors: Herbert Kramer, Penzing (DE); Josef Fuenfer, Konigsbrunn (DE)

Correspondence Address: ABELMAN, FRAYNE & SCHWAB, 666 THIRD AVENUE, 10TH FLOOR, NEW YORK, NY, 10017, US

(21) Appl. No.: 12/151,030

(22) Filed: May 1, 2008

(30) Foreign Application Priority Data
May 3, 2007 (DE) 10 2007 000 255.8

(51) Int. Cl. B25D 17/26

(52) U.S. Cl. 173/128

(57) ABSTRACT

A hand-held power tool a percussion mechanism (2) of which includes a percussion piston (4) displaceable by an air spring (3) of the power tool for applying blows to an anvil (5) that is dust-tightly and lubricant-tightly sealed with respect to its guide by two axially offset sealing elements (8) between which a lubricant chamber (9) for receiving a barrier lubricant (10) is formed.

### BACKGROUND OF THE INVENTION

1. Field of the Invention

The present invention relates to a hand-held power tool and, in particular, to a percussion power tool with a lubricated air spring-percussion mechanism assembly and, specifically, to a combination hammer or chisel hammer.

2. Description of the Prior Art

In percussion hand-held power tool, the axially reciprocating parts of the air-spring-percussion mechanism assembly and guide elements are subjected to high tribological stresses. In order to prevent an excessive wear, at least separate parts of the percussion mechanism are lubricated, and the penetration of an abrasive dust into the lubricated percussion mechanism is prevented where possible.

German Publication DE 30 39 617 discloses a percussion power tool in which an anvil is arranged between an air spring-driven percussion piston and an end surface of the working tool. The anvil is sealed by an O-ring with respect to its guide sleeve in a sealing plane, dust-tightly and lubricant-tightly sealing the lubricated percussion mechanism with a percussion piston relative to a dust-loaded working tool holder.

According to German Publications DE 100 30 962 and DE 100 19 071, an anvil, which is displaceable in a widened tool guide, is sealed by two axially offset seals that, thus, form two, axially offset sealing planes. No free space is available between the two seals.

An object of the present invention is to further improve the sealing of a lubricated air spring-percussion mechanism assembly of a hand-held power tool.

### SUMMARY OF THE INVENTION

This and other objects of the present invention, which will become apparent hereinafter, are achieved by providing a hand-held power tool a percussion mechanism of which has an anvil, guide means for the anvil, at least two, axially offset relative to each other, sealing elements for dust-tightly and lubricant-tightly sealing the anvil with respect to the anvil guide means, a lubricant chamber formed between the at least two sealing elements for receiving a barrier lubricant, and a percussion piston for applying blows to the anvil and driven by air spring of hand-held power tool.

The barrier lubricant forms a barrier against dust at the working tool side of the percussion mechanism and against percussion mechanism lubricant at the percussion piston side. Dust, which can possibly penetrate into the barrier lubricant chamber at the working tool side, and/or percussion mechanism lubricant (e.g., a synthetic gear oil), which can possibly penetrate in the barrier lubricant chamber at the percussion piston side, becomes bonded with the barrier lubricant. The barrier lubricant, which is contaminated with the dust and the percussion mechanism lubricant, can be easily replaced during servicing of the power tool.

Advantageously, the barrier lubricant consists of grease, advantageously, of a rolling bearing grease. The grease insures a reliable bonding of the penetrated dust and/or lubricant.

Advantageously, at least one of the at least two sealing elements is formed of a centering ring fixedly secured in the guide means (e.g., in the guide sleeve for the working tool or percussion piston), and a dynamic seal arranged in the centering ring coaxially therewith. In this case, the tribological stress takes place excessively between the anvil and the centering ring. Both parts are considered to be wearable, and can be economically replaced after being weared in excess of a predetermined amount.

Advantageously, the centering ring is formed of two annular discs assembled axially together and fixedly connected with each other, advantageously radially pressed into each other. An axially sealing, dynamic O-ring is arranged coaxially therebetween in a space between the two discs. This insures a technologically simple manufacturing of the centering ring.

The centering ring further advantageously includes a coaxial outer static seal such as, e.g., a lamella seal. Thereby, a possible coaxial outer, with respect to the guide sleeve, open bypass is sealed.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiments, when read with reference to the accompanying drawings.

### BRIEF DESCRIPTION OF THE DRAWINGS

The drawings show:

FIG. 1 a cross-sectional view of a percussion mechanism of a hand-held power tool according to the present invention; and

FIG. 2 a cross-sectional view of a detail of another embodiment of the inventive percussion mechanism.

### DETAILED DESCRIPTION OF THE PREFERRED EMBODIMENTS

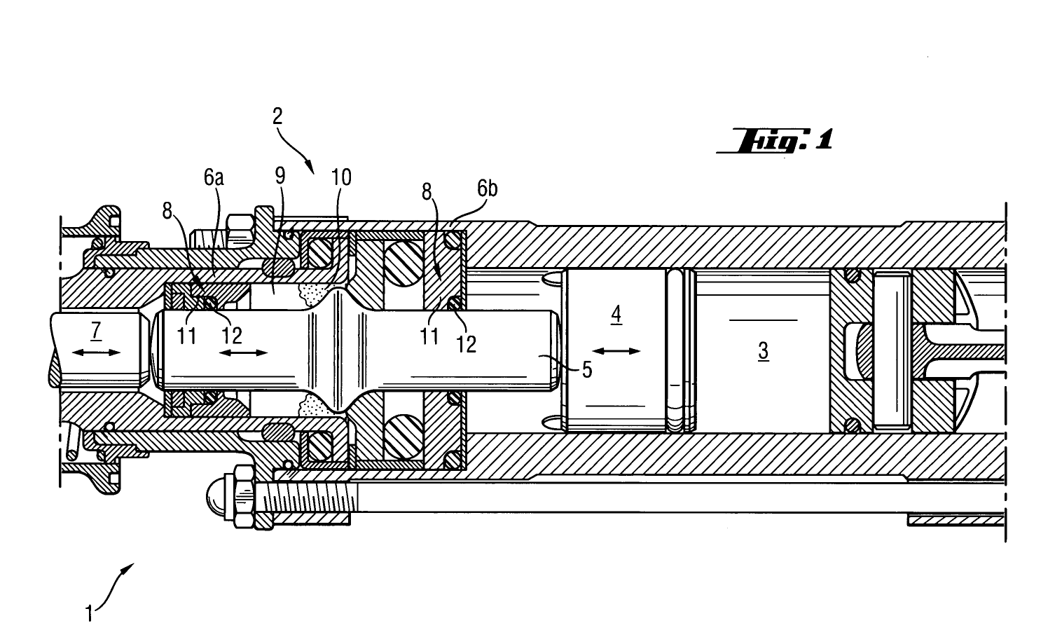

An axially percussion hand-held power tool 1, which is shown in FIG. 1 and is formed as a chisel hammer, has a percussion mechanism 2 that includes a reciprocating percussion piston 4 that is driven by an air spring 3 and applies blows to an anvil 5. The anvil 5 is sealed, dust-tightly and lubricant-tightly, by two, axially offset sealing elements 8 with respect to its two guides (here, specifically, guide sleeves 6a and 6b for the working tool 7 and for the percussion piston 4). A lubricant chamber 9 is formed between the two sealing elements 8. The lubricant chamber 9 contains a barrier lubricant 10 in form of a rolling bearing grease. Both sealing elements 8 are formed as centering rings 11 with an inwardly arranged, coaxial dynamic seal 12 and are fixedly mounted on respective guides (here, the guide sleeves 6a, 6b).

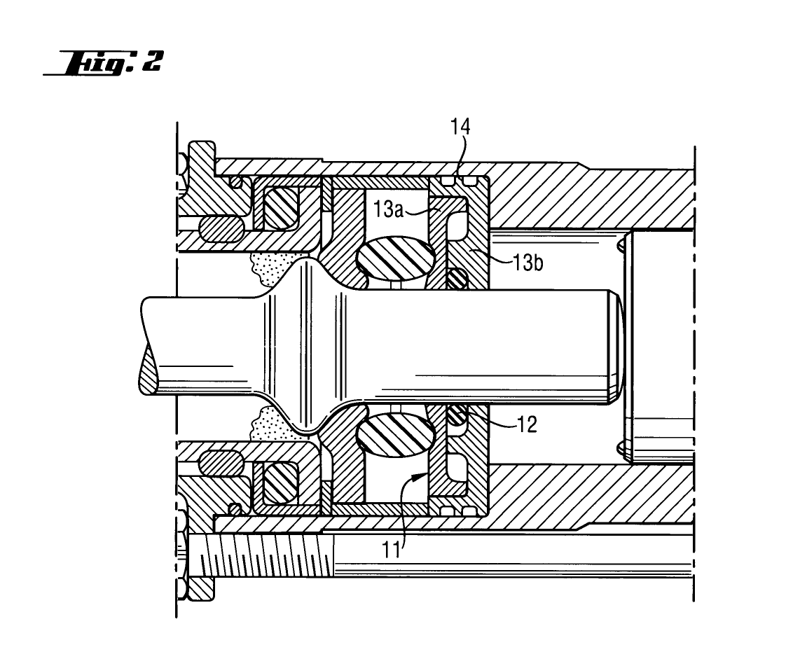

According to FIG. 2, the centering ring 11 is formed of two, axially assembled with each other, annular discs 13a, 13b which are radially pressed into each other and between which an axially sealing, dynamic seal 12 in form of an O-ring is coaxially inwardly arranged. The O-ring is formed of a silicone rubber. In addition, the centering ring 11 has a coaxial outer, static seal 14 in form of a lamella seal.

Though the present invention was shown and described with references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. A hand-held power tool, comprising a percussion mechanism (2) including an anvil (5), guide means for the anvil (5), at least two, axially offset relative to each other, sealing elements (8) for dust-tightly and lubricant-tightly sealing the anvil (5) with respect to the anvil guide means, a lubricant chamber (9) formed between the at least two sealing elements (8) for receiving a barrier lubricant (10); and a percussion piston (4) for applying blows to the anvil (5); and an air spring for displacing the percussion piston (4).

2. A percussion mechanism according to claim 1, wherein the barrier lubricant (10) comprises grease.

3. A percussion mechanism according to claim 1, wherein at least one of the at least two sealing elements (8) is formed of a centering ring (11) fixedly secured in the guide means, and a dynamic seal (12) arranged in the centering ring (11) coaxially therewith.

4. A percussion mechanism according to claim 3, wherein the centering ring (11) is formed of two annular discs (13a, 13b) assembled axially together and fixedly connected with each other.

5. A percussion mechanism according to claim 4, wherein the centering ring (11) comprises an outer static seal (14) arranged coaxially therewith.
